(19) United States
(12) Patent Application Publication
(10) Pub. No.: US 2015/0099615 A1
(43) Pub. Date: Apr. 9, 2015

(54) CONTAINER-FORMING PROCESS AND MACHINE

(71) Applicant: Berry Plastics Corporation, Evansville, IN (US)

(72) Inventors: Chris K. Leser, Evansville, IN (US); Cody J. Stillwell, Evansville, IN (US)

(21) Appl. No.: 14/507,461

(22) Filed: Oct. 6, 2014

Related U.S. Application Data
(60) Provisional application No. 61/887,087, filed on Oct. 4, 2013.

(51) Int. Cl. B31B 1/64; B31B 17/00; B31B 1/28

(52) U.S. Cl. CPC B31B 1/64; B31B 1/28; B31B 17/00; B31B 2217/064
USPC 493/105; 493/134

(57) ABSTRACT

A heated forced-air nozzle may be used in a container-forming machine to heat portions of an insulative container during a container-forming process. The heated forced-air nozzle is formed to include a heated-air passageway which is in fluid communication with a source of heated forced air. The heated forced-air nozzle is formed to include a series of circumferentially spaced-apart passageways in which heated forced air is communicated through from the heated-air passageway.

### PRIORITY CLAIM

This application claims priority under 35 U.S.C. §119(e) to U.S. Provisional Application Ser. No. 61/887,087, filed Oct. 4, 2013, which is expressly incorporated by reference herein.

### BACKGROUND

The present disclosure relates to a machine for forming containers, and in particular to insulated containers. More particularly, the present disclosure relates to a container-forming machine that uses a body blank and a floor blank to form an insulated container.

### SUMMARY

According to the present disclosure, a container-forming machine applies heat to portions of an insulative container to cause bonds formed between components included in the insulative container to be maximized so that leaks are minimized. The container-forming machine applies heat to the components of the insulative container using heated forced air directed onto the components using a heated forced-air nozzle.

In illustrative embodiments, the heated forced-air nozzle includes an air ring configured to communicate the flow of heated forced air onto the components and a ring mount interconnecting the air ring to a source of heated forced air. The heated forced-air nozzle further includes spacer means for varying a location of the first air ring relative to the components to cause the first air ring to be located at an appropriate axial location for various sizes and shapes of insulative containers so that heat from the flow of heated forced air is directed to a desired location on the components regardless of the size and shape of the insulative containers.

In illustrative embodiments, the first air ring is formed to include a series of circumferentially spaced-apart passageways and each circumferentially spaced-apart passageway is configured to provide means for directing a first stream of heated forced air included in flow to be directed against the components included in the insulative container while a second stream of heated forced air included in the flow is directed away from the components included in the insulative container. The second stream is directed away from the components to minimize damage associated with burning.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a diagrammatic view of a container-forming process in accordance with the present disclosure showing that the container-forming process includes the operations of staging materials for use in a container-forming machine, forming a body included in an insulative container, and forming a brim to establish the insulative container in accordance with the present disclosure;

FIG. 2A is a diagrammatic view of a first embodiment of a body-forming operation in accordance with the present disclosure showing that the body-forming operation includes forming a floor unit, forming a sleeve unit, heating a floor-retaining flange included in the sleeve unit, heating a platform-support member included in the floor unit, and coupling the floor unit to the sleeve unit to produce the body of the insulative container;

FIG. 2B is a diagrammatic view of a second embodiment of a body-forming operation in accordance with the present disclosure showing that the body-forming operation includes forming a sleeve unit, forming a floor unit, heating a floor-retaining flange included in the sleeve unit, heating a platform-support member included in the floor unit, and coupling the floor unit to the sleeve unit to produce the body of the insulative container;

FIG. 3 is a diagrammatic and perspective view showing the sleeve unit wrapped around a male mandrel included in the container-forming machine, the floor unit spaced apart from the sleeve unit, and a heated forced-air nozzle spaced apart from the floor unit and suggesting that the floor unit is located inside a floor-receiving space formed in the sleeve unit prior to heat being applied by the heated forced-air nozzle as suggested in FIG. 4;

FIG. 4 is a diagrammatic view showing the heating operation included in the body forming operation in which the heated forced-air nozzle has been inserted in the floor-receiving space and heated forced air is directed toward the platform-support member of the floor unit and the floor-retaining flange of the body unit;

FIG. 5 is an elevation view of the heated forced-air nozzle of FIGS. 3 and 4 showing that the heated forced-air nozzle includes, from top to bottom, a first air ring formed to include a series of circumferentially spaced-apart passageways through which heated air is communicated to the floor unit, a first spacer ring, a second air ring formed to include a series of circumferentially spaced-apart passageways, a third air ring formed to include a series of circumferentially spaced-apart passageways, a second spacer ring, a third spacer ring, and a nozzle mount located along a mandrel axis of the heated forced-air nozzle and configured to couple the heated forced-air nozzle to a source of heated forced air;

FIG. 6 is a sectional view taken along line 6-6 of FIG. 5 showing that each passageway included in the first, second, and third air rings is arranged to extend downwardly along a passageway axis and that an acute angle is defined between the passageway axis and the mandrel axis;

FIG. 7 is a view similar to FIG. 5 showing that the various air rings and spacer rings have been spaced-apart from one another to suggest that the various air rings and spacer rings are movable relative to one another and that the various air rings and spacer rings may be interchanged to provide for variation of the nozzle as needed for various different container designs;

FIG. 8 is a sectional view taken along line 8-8 of FIG. 7 showing that in each of the air rings, the passageways formed in the air rings are arranged to extend downwardly along the passageway axis at the acute angle to direct the flows of heated forced air downwardly and out of the floor-receiving space included in a container as shown in FIG. 4;

FIG. 9 is an elevation view of another embodiment of a heated forced-air nozzle in accordance with the present disclosure with portions broken away to reveal that the heated forced-air nozzle includes, from bottom to top, a first air ring formed to include a series of circumferentially spaced-apart passageways through which heated is communicated to the floor unit, a first spacer ring, a second air ring formed to include a series of circumferentially spaced-apart passageways, a second spacer ring, a third air ring formed to include a series of circumferentially spaced-apart passageways, a third spacer ring, a fourth air ring formed to include a series of circumferentially spaced-apart passageways, a fourth spacer ring, and a nozzle mount located along the mandrel axis of the heated forced-air nozzle and configured to couple the heated forced-air nozzle to the source of heated forced air;

FIG. 10 is a diagrammatic view of another embodiment of a heated forced-air nozzle in accordance with the present disclosure showing that the heated forced-air nozzle includes a set of air rings with each ring formed to include a series of circumferentially spaced-apart passageways, a set of spacers rings with each spacer ring including any suitable number of sub-ring layers, and a nozzle mount located along the mandrel axis of the heated forced-air nozzle and configured to couple the heated forced-air nozzle to the source of heated forced air; and

FIG. 11 is a diagrammatic view of a heating operation being performed on a relatively larger insulative container and showing the heated forced-air nozzle of FIG. 9 inserted in the floor-receiving space and heated forced air being directed toward the platform-support member of the floor unit and the floor-retaining flange of the body unit.

### DETAILED DESCRIPTION

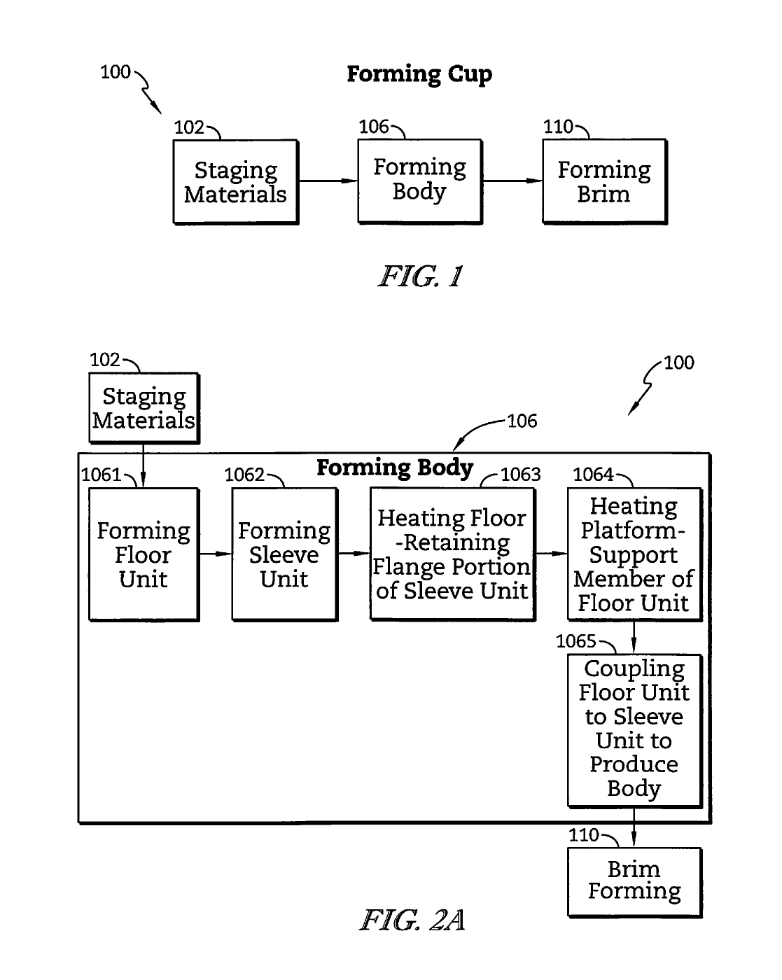

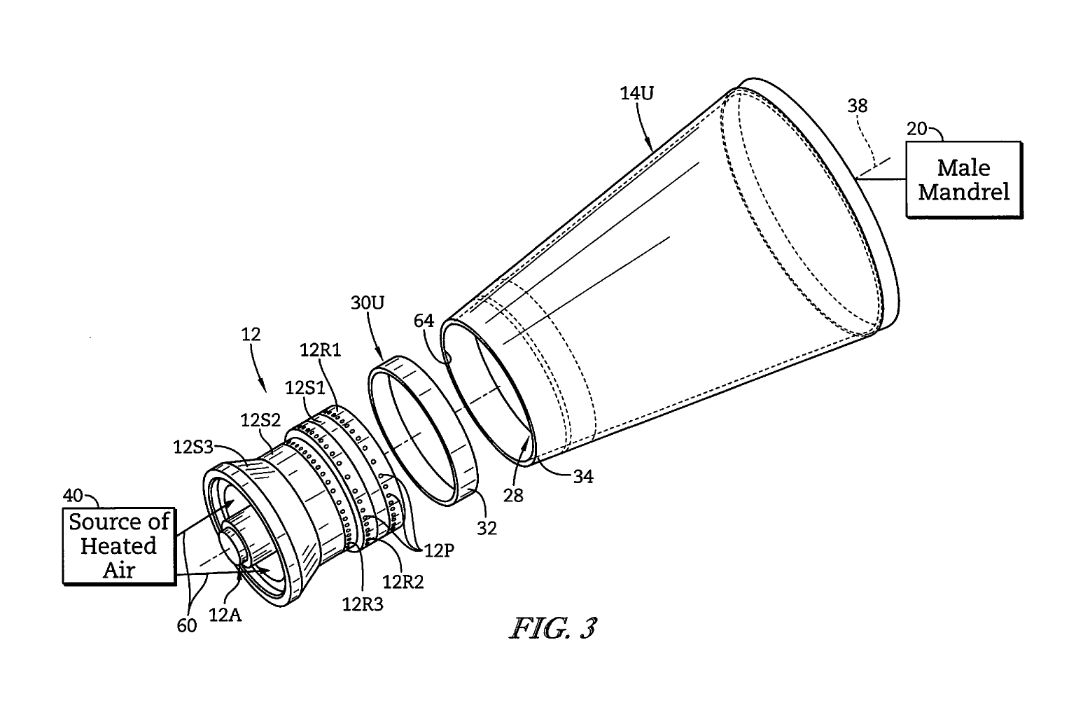

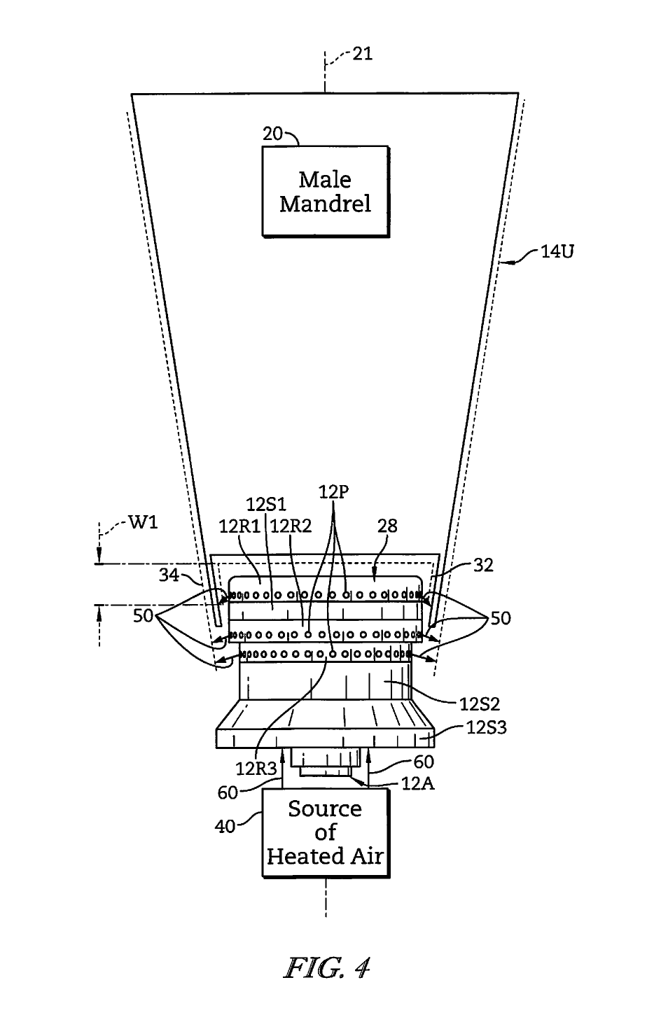

A container-forming process 100 in accordance with the present disclosure includes a staging materials operation 102, a forming a body-forming operation 106, and forming a brim-forming operation 110 as shown in FIG. 1. Container-forming process 100 uses a container-forming machine to form an insulative cup. During container-forming process 100, portions of a side-wall blank and a floor blank are heated by a heated forced-air nozzle 12 as suggested in FIGS. 3 and 4 to maximize bonding of the floor to the body of the insulative container without damaging the floor or the body.

Damage may take the form of burning which is any interruption or destruction of the surface of the container. Damage may also include burning which results in surface burns, unintended discoloration on the surface, or burns which extend through the container. Damage may also include holes of about 0.001 inches or greater formed in the container whether the holes extend completely through the container or only part ways through the container.

Heated forced-air nozzle 12 includes a set of spacer rings 12S and air rings as shown in FIGS. 3 and 4. Each air ring is formed to include a series of circumferentially spaced-apart passageways 12P which communicate heated forced air 16 onto specific regions of a sleeve unit 14U and a floor unit 30U as suggested in FIGS. 3 and 4. Each passageway 12P is arranged to extend downwardly from a horizontal reference plane 42 as shown in FIGS. 6 and 8. As a result, a portion of heated forced air 16 is directed downwardly away from sleeve unit 14U and floor unit 30U so that damage to sleeve unit 14U and floor unit 30U is minimized during heating. Spacer rings 12S and air rings 12R may be configured in various suitable combinations and thicknesses so that heated forced-air nozzle 12 may be used with various sizes and shapes of containers. As a result, heated forced-air nozzle 12 is modular and customizable.

A container-forming process 100 in accordance with the present disclosure begins with staging materials operation 102 as shown in FIG. 1. During staging materials operation 102 materials are staged for use by the container-forming machine. Next, process 100 proceeds to a forming a body-forming operation 106 occurs in which a body of an insulative container is formed using a male mandrel 20. Process 100 then moves on to a brim-forming operation 110 in which a rolled brim is formed on the body to establish the insulative container. In one example, the container-forming machine is a Paper Machinery Corporation PMC 2000S series container forming machine. However, any other suitable alternative cup-forming machines may be used. Additional description of a container-forming machine and a container-forming process in accordance with the present disclosure is included in U.S. patent application Ser. No. 13/961,411, filed on Aug. 7, 2012, which is hereby expressly incorporated by reference herein in its entirety.

Additional description of a container formed using the container-forming machine and the container-forming process in accordance with the present disclosure is included in U.S. patent application Ser. No. 13/491,007, filed on Jun. 7, 2012, which application is hereby expressly incorporated by reference herein in its entirety. The container is made, for example, from an insulative cellular non-aromatic polymeric material. Disclosure relating to such insulative cellular non-aromatic polymeric material is included in U.S. application Ser. No. 13/491,327, filed Jun. 7, 2012 and U.S. application Ser. No. 14/462,073, filed Aug. 18, 2014, each of which application is expressly incorporated herein in its entirety

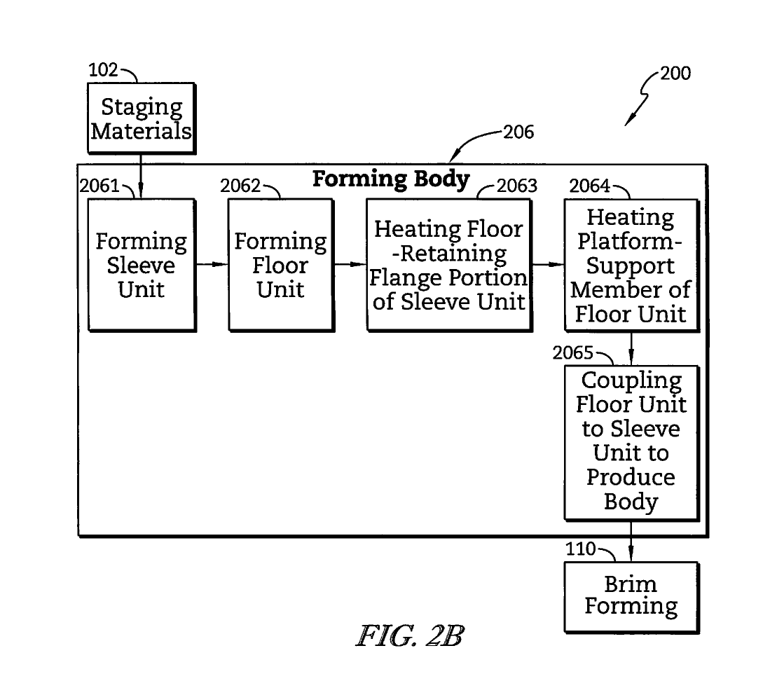

Forming a body-forming operation 106 includes a forming a floor unit operation 1061, forming a sleeve unit operation 1062, a first heating operation 1063, a second heating operation 1064, and a coupling operation 1065 as shown in FIG. 2A. Forming a floor unit operation 1061 forms a floor unit 30U using a floor blank provided in staging materials operation 102. Forming a sleeve unit operation 1062 forms a sleeve unit 14U using a body blank provided in staging materials operation 102. First heating operation 1063 applies heat to a floor-retaining flange 34 included in sleeve unit 14U using heated forced-air nozzle 12. Second heating operation 1064 applies heat to platform-support member 32 included in floor unit 30U using heated forced-air nozzle 12. Coupling operation 1065 couples floor-retaining flange 34 to platform-support member 32 to form a body included in the insulative container. In one example, heating operations 1063 and 1064 may be performed in series or parallel to one another.

Another embodiment of a container-forming process 200 in accordance with the present disclosure is shown in FIG. 2B. Container-forming process 200 begins with staging materials operation 102 and continues to a forming a body-forming operation 206 in which a body of an insulative container is formed. Process 200 then moves on to brim forming operation 110 in which the rolled brim is formed on the body to establish the insulative container. In one example, the container-forming machine is a Horauf BMP 200 series container forming machine. However, any other suitable alternative cup-forming machines may be used.

Body-forming operation 206 includes a forming a sleeve unit operation 2061, forming a floor unit operation 2062, a first heating operation 2063, a second heating operation 2064, and a coupling operation 2065 as shown in FIG. 2B. Forming a sleeve unit operation 2061 forms sleeve unit 14U using the body blank provided in staging materials operation 102. Forming a floor unit operation 2062 forms the floor unit 30U using the floor blank provided in staging materials operation 102. First heating operation 2063 applies heat to floor-retaining flange 34 included in sleeve unit 14U using heated forced-air nozzle 12. Second heating operation 2064 applies heat to platform-support member 32 included in floor unit 30U using heated forced-air nozzle 12. Coupling operation 1065 couples floor-retaining flange 34 to platform-support member 32 to form a body included in the insulative container. In one example, heating operations 2063 and 2064 may be performed in series or parallel to one another.

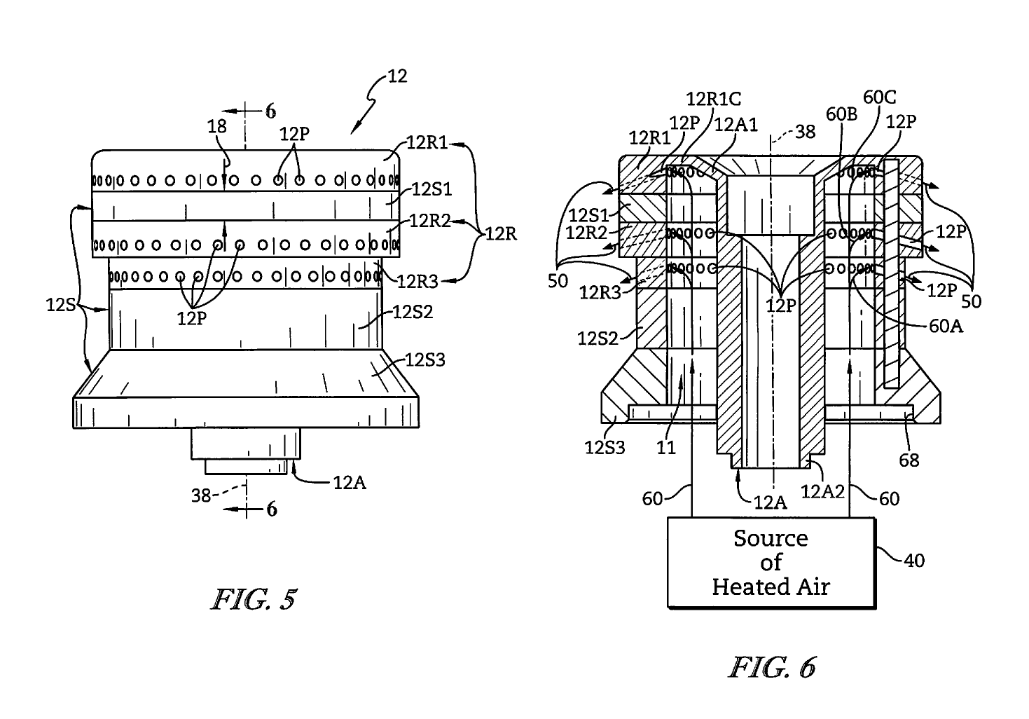

Heating operations 1063, 1064 of body-forming operation 106 and heating operations 2063, 2064 of body forming operation 206 use heated forced-air nozzle 12 to apply heated forced air 50 to platform-support member 32 and floor-retaining flange 34 as suggested in FIG. 4. Heated forced-air nozzle 12 includes a ring mount 12A, a set of air rings 12R, and spacer means 12S for locating air rings 12R to cause heated force air to be directed onto floor unit 30U and sleeve unit 14U during formation of an insulated container as suggested in FIG. 5-8.

Ring mount 12A is located along a mandrel axis 38 of heated forced-air nozzle 12. Ring mount 12A is coupled to a source 40 of heated forced air and is formed to include a forced-air conduit 11 therein to receive heated forced air from source 40 therein. The set of air rings 12R includes a first air ring 12R1, a second air ring 12R2, and a third air ring 12R3. Each of the air rings 12R1, 12R2, 12R3 is formed to include a series of circumferentially spaced-apart passageways 12P as shown in FIGS. 5-8. Air from source 40 of heated forced air moves through forced-air conduit 11 through each of the passageways 12P to engage sleeve unit 14U and floor unit 30U as suggested in FIG. 4.

Spacer means 12S is, for example, a set of spacer rings 12S. The set of spacer rings 12S includes a first spacer ring 12S1, a second spacer ring 12S2, and a third spacer ring 12S3 as shown in FIGS. 5-8. As shown in FIG. 5, spacer rings 12S and air rings 12R are arranged in order as follows: first air ring 12R1, first spacer ring 12S1, second air ring 12R2, third air ring 12R3, second spacer ring 12S2, and third spacer ring 12S3. The order and sizing of the spacer rings 12S and air ring 12R may be varied according to the container size being formed.

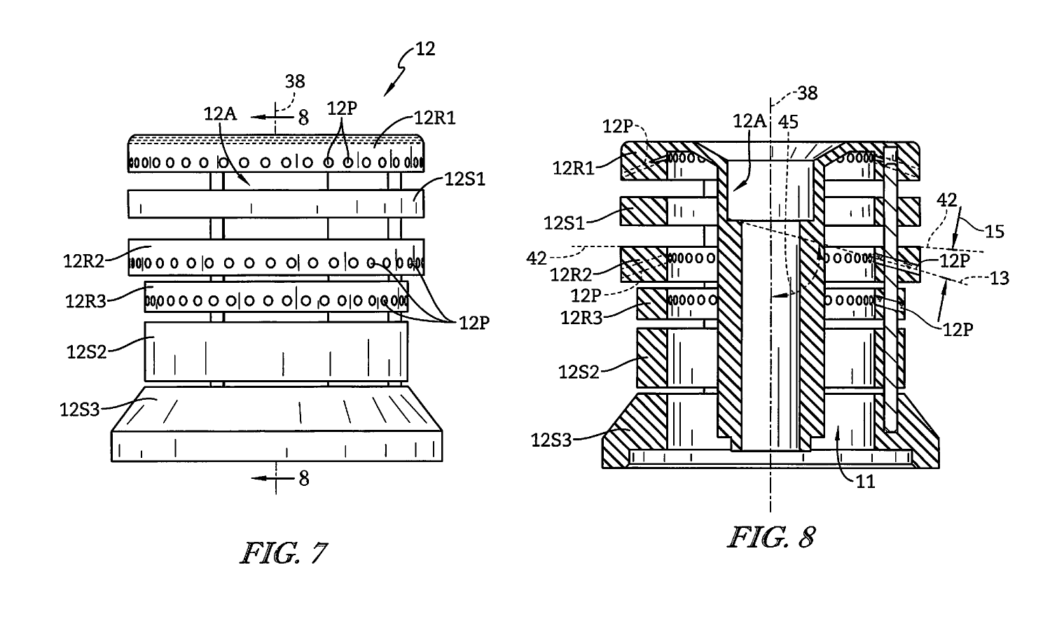

As shown, for example, in FIG. 7, each spacer ring 12S1, 12S2, 12S3 and each air ring 12R1, 12R2, 12R3 may be moved relative to one another to provide for various configurations of heated forced-air nozzle 12. Various air rings and spacer rings may be interchanged to provide for variation of the configured nozzle as needed for various different container designs.

As shown in FIG. 8, each passageway 12P formed in each air ring 12R1, 12R2, 12R3 is arranged to extend downwardly along a passageway axis 13 from a horizontal reference plane 42. Passageway axis 13 and horizontal reference plane 42 cooperate to define an angle 15 therebetween as shown in FIG. 8. In one example, angle 15 is in a range of greater than zero degrees to about 45 degrees. In another example, angle 15 is in a range of greater than zero degrees to about 30 degrees. In still yet another example, angle 15 is in a range of between about 5 degrees and about 30 degrees. In another example, angle 15 is in a range of about 5 degrees to about 20 degrees. In another example, angle 15 is in a range of about 10 degrees to about 20 degrees. In another example, angle 15 is about 15 degrees. As a result of angle 15 being greater than zero, a portion of heated forced air 50 moving through nozzle 12 is directed downwardly out of floor-receiving space 28 so as to minimize burning of material included in platform-support member 32 and floor-retaining flange 34.

In another example, angle 15 is in a range of greater than zero degrees to about 30 degrees. In still yet another example, angle 15 is in a range of between about 5 degrees and about 30 degrees. In another example, angle 15 is in a range of about 5 degrees to about 20 degrees. In another example, angle 15 is in a range of about 10 degrees to about 20 degrees. In another example, angle 15 is about 15 degrees. As a result of angle 15 being greater than zero, a portion of heated forced air 50 moving through nozzle 12 is directed downwardly out of floor-receiving space 28 so as to minimize burning of material included in platform-support member 32 and floor-retaining flange 34.

As suggested in FIG. 4 and shown in FIG. 8, each passageway 12P formed in each air ring 12R1, 12R2, 12R3 is arranged to extend downwardly from male mandrel 20. Male mandrel 20 extends along a mandrel axis 21 as shown in FIGS. 4 and 8. Passageway axis 13 extends through and intersects mandrel axis 21 to define an acute angle 45 therebetween as shown in FIG. 8. In one example, acute angle 45 is in a range of about 45 degrees to about 90 degrees. In one example, acute angle 45 is in a range of about 60 degrees to about 90 degrees. In one example, acute angle 45 is in a range of about 70 degrees to about 85 degrees. In one example, acute angle 45 is in a range of about 70 degrees to about 80 degrees. In one example, acute angle 45 is about 75 degrees.

In another example, one set of passageways formed in an air ring may be arranged to extend outwardly parallel to the horizontal reference plane 42. In another example, one set of passageways formed in an air ring may be arranged to extend upwardly from the horizontal reference plane 42. The upwardly extending passageways and horizontal reference plane 42 cooperate to define a second angle. In one example, angle 15 is in a range of greater than zero degrees to about 45 degrees. In another example, the second angle is in a range of greater than zero degrees to about 30 degrees. In another example, the second angle is in a range of between about 5 degrees and about 30 degrees. In another example, the second angle is in a range of about 5 degrees to about 20 degrees. In another example, the second angle is in a range of about 10 degrees to about 20 degrees. In another example, the second angle is about 15 degrees.

The container-forming machine may include a heater station including source 40 of heated force air and heated forced-air nozzle 12. The heater station may also include a gear shaft coupled to heated forced-air nozzle 12 to move heated forced-air nozzle 12 back and forth relative to sleeve unit 14U.

In another example, a heater station in accordance with the present disclosure may have an end closest to sleeve unit 14U that is liquid cooled. Liquid cooling the end of the heater station is configured to reduce a temperature of heated forced air to a point in which damage, such as burning of material included in platform-support member 32 and floor-retaining flange 34, is minimized.

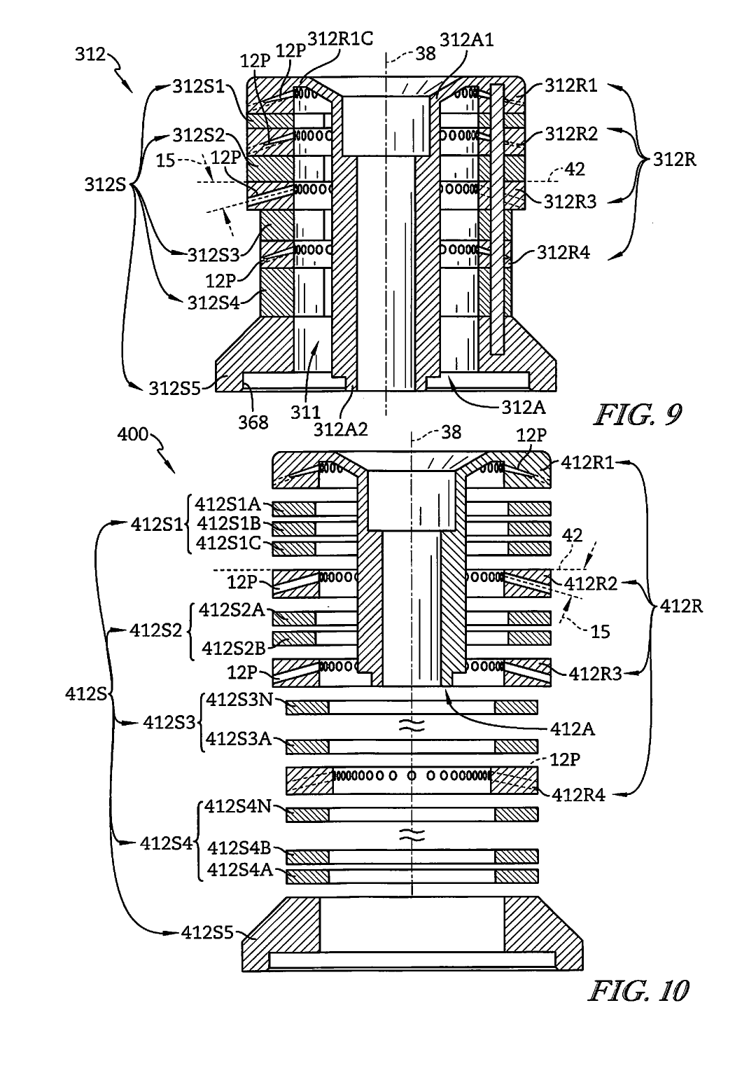

Heating operations 1063, 1064 of body-forming operation 106 and heating operations 2063, 2064 of body forming operation 206 use a second embodiment of a heated forced-air nozzle 312 to apply heated forced air 50 to platform-support member 32 and floor-retaining flange 34. Heated forced-air nozzle 312 includes a nozzle mount 312A, a set of air rings 312R, and set of spacers 312S as shown in FIG. 9.

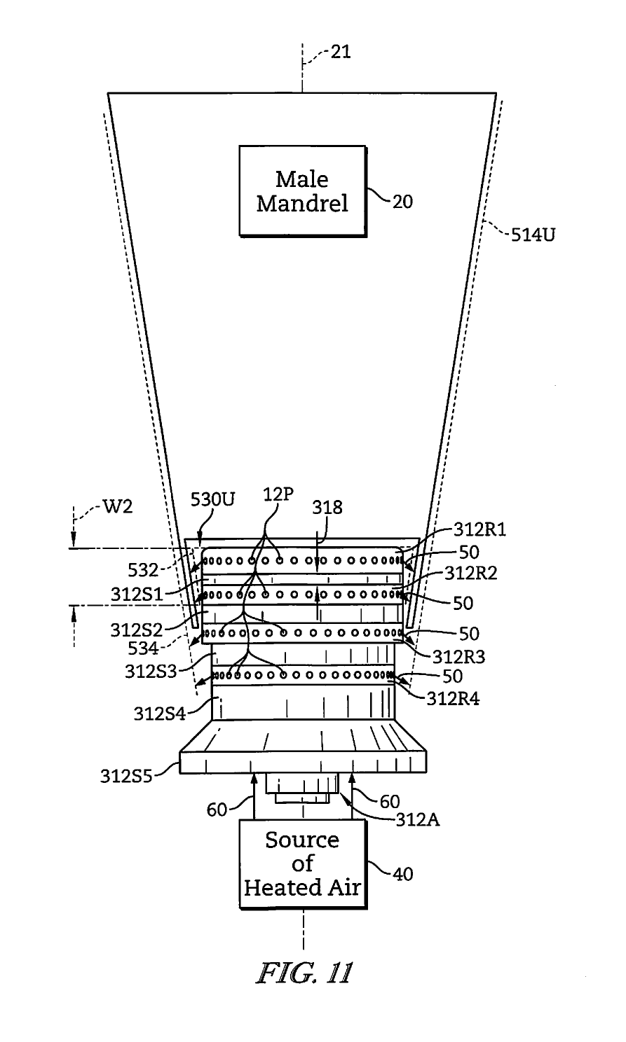

Nozzle mount 312A is located along mandrel axis 38 of heated forced-air nozzle 312. Nozzle mount 312A is coupled to source 40 of heated forced air. The set of air rings 312R includes a first air ring 312R1, a second air ring 31282, a third air ring 312R3, and a fourth air ring 312R4. Each of the air rings 312R1, 31282, 312R3, 313R4 is formed to include a series of circumferentially spaced-apart passageways 12P as shown in FIG. 9. Air from source 40 of heated forced air is forced through each of the passageways 12P to engage sleeve unit 14U and floor unit 30U. The set of spacer rings 312S includes a first spacer ring 312S1, a second spacer ring 312S2, a third spacer ring 312S3, a fourth spacer ring 312S4, and a fifth spacer ring 412S5 as shown in FIG. 10. Spacer rings 412S and air rings 412R are arranged in order as follows: first air ring 412R1, first spacer ring 412S1, second air ring 412R2, second spacer ring 412S2, third air ring 413R3, third spacer ring 412S3, fourth air ring 412R4, a fourth spacer ring 412S4, and a fifth spacer ring 412S5. The order and sizing of the spacer rings 412S and air ring 412R may be varied according to the container size being formed.

As shown, for example, in FIG. 10, each spacer ring 412S1, 412S2, 412S3, 412S4, 412S5 and each air ring 412R1, 412R2, 412R3, 412R4 may be moved relative to one another to provide for various configurations of heated forced-air nozzle 412. Various air rings and spacer rings may be interchanged to provide for variation of the configured nozzle as needed for various different container designs.

As shown in FIG. 9, each passageway 12P formed in each air ring 312R1, 31282, 312R3, 312R4 is arranged to extend downwardly from a horizontal reference plane 42. Passageway 12P and horizontal reference plane 42 cooperate to define angle 15 therebetween as shown in FIG. 9. In one example, angle 15 is in a range of greater than zero degrees to about 45 degrees. In another example, angle 15 is in a range of greater than zero degrees to about 30 degrees. In still yet another example, angle 15 is in a range of between about 5 degrees and about 30 degrees. In another example, angle 15 is in a range of about 5 degrees to about 20 degrees. In another example, angle 15 is in a range of about 10 degrees to about 20 degrees. In another example, angle 15 is about 15 degrees. As a result of angle 15 being greater than zero, a portion of heated forced air 50 moving through nozzle 12 is directed downwardly out of floor-receiving space 28 so as to minimize burning of material included in platform-support member 32 and floor-retaining flange 34.

In another example, one set of passageways formed in an air ring may be arranged to extend outwardly parallel to the horizontal reference plane 42. In another example, one set of passageways formed in an air ring may be arranged to extend upwardly from the horizontal reference plane 42. The upwardly extending passageways and horizontal reference plane 42 cooperate to define a second angle. In one example, angle 15 is in a range of greater than zero degrees to about 45 degrees. In another example, the second angle is in a range of greater than zero degrees to about 30 degrees. In another example, the second angle is in a range of between about 5 degrees and about 30 degrees. In another example, the second angle is in a range of about 5 degrees to about 20 degrees. In another example, the second angle is in a range of about 10 degrees to about 20 degrees. In another example, the second angle is about 15 degrees.

Heating operations 1063, 1064 of body-forming operation 106 and heating operations 2063, 2064 of body forming operation 206 use a third embodiment of a heated forced-air nozzle 412 to apply heated forced air 50 to platform-support member 32 and floor-retaining flange 34. Heated forced-air nozzle 412 includes a nozzle mount 412A, a set of air rings 412R, and set of spacers 412S as shown in FIG. 10.

Nozzle mount 412A is located along mandrel axis 38 of heated forced-air nozzle 412. Nozzle mount 412A is coupled to source 40 of heated forced air. The set of air rings 412R includes a first air ring 412R1, a second air ring 412R2, a third air ring 412R3, and a fourth air ring 412R4. Each of the air rings 412R1, 412R2, 412R3, 413R4 is formed to include a series of circumferentially spaced-apart passageways 12P as shown in FIG. 10. Air from source 40 of heated forced air is forced through each of the passageways 12P to engage sleeve unit 14U and floor unit 30U. The set of spacer rings 412S includes a first spacer ring 412S1, a second spacer ring 412S2, a third spacer ring 412S3, a fourth spacer ring 412S4, and a fifth spacer ring 412S5 as shown in FIG. 10. As shown in FIG. 10, spacer rings 412S and air rings 412R are arranged in order as follows: first air ring 412R1, first spacer ring 412S1, second air ring 412R2, second spacer ring 412S2, third air ring 413R3, third spacer ring 412S3, fourth air ring 412R4, a fourth spacer ring 412S4, and a fifth spacer ring 412S5. The order and sizing of the spacer rings 412S and air ring 412R may be varied according to the container size being formed.

As shown, for example, in FIG. 10, each spacer ring 412S1, 412S2, 412S3, 412S4, 412S5 and each air ring 412R1, 412R2, 412R3, 412R4 may be moved relative to one another to provide for various configurations of heated forced-air nozzle 412. As shown in FIG. 10, each spacer ring may include one or more sub-ring layers. In one example, first spacer ring 412S1 includes a first sub-ring layer 412S1A, a second sub-ring layer 412S1B, and third sub-ring layer 412S1C. In another example, third spacer ring 412S3 includes a first sub-ring layer 412S3A, additional sub-ring layers (not shown), and a last sub-ring layer 412S3N. Here, last sub-ring layer 412S3N is used to indicate that any suitable number of sub-ring layers may be used. As a result, various air rings and spacer rings with any suitable number of sub-ring layers may be interchanged to provide for variation of the configured nozzle as needed for various different container designs.

As shown in FIG. 10, each passageway 12P formed in each air ring 412R1, 412R2, 412R3, 412R4 is arranged to extend downwardly from a horizontal reference plane 42. Passageway 12P and horizontal reference plane 42 cooperate to define angle 15 therebetween as shown in FIG. 10. In one example, angle 15 is in a range of greater than zero degrees to about 45 degrees. In another example, angle 15 is in a range of greater than zero degrees to about 30 degrees. In still yet another example, angle 15 is in a range of between about 5 degrees and about 30 degrees. In another example, angle 15 is in a range of about 5 degrees to about 20 degrees. In another example, angle 15 is in a range of about 10 degrees to about 20 degrees. In another example, angle 15 is about 15 degrees. As a result of angle 15 being greater than zero, a portion of heated forced air 50 moving through nozzle 12 is directed downwardly out of floor-receiving space 28 so as to minimize burning of material included in platform-support member 32 and floor-retaining flange 34.

In another example, one set of passageways formed in an air ring may be arranged to extend outwardly parallel to the horizontal reference plane 42. In another example, one set of passageways formed in an air ring may be arranged to extend upwardly from the horizontal reference plane 42. The upwardly extending passageways and horizontal reference plane 42 cooperate to define a second angle. In one example, angle 15 is in a range of greater than zero degrees to about 45 degrees. In another example, the second angle is in a range of greater than zero degrees to about 30 degrees. In another example, the second angle is in a range of between about 5 degrees and about 30 degrees. In another example, the second angle is in a range of about 5 degrees to about 20 degrees. In another example, the second angle is in a range of about 10 degrees to about 20 degrees. In another example, the second angle is about 15 degrees.

A container-forming machine 60 [360] in accordance with the present disclosure comprises heated forced-air source 40, male mandrel 20, and a heated forced-air nozzle 12 [312]. Heated forced-air source 40 is configured to provide a flow 62 of heated forced air. Male mandrel 20 is arranged to extend along mandrel axis 21 and formed to include a floor-receiving aperture 64 arranged to open into a floor-receiving space 28 formed in male mandrel 20.

Heated forced-air nozzle 12 [312] is coupled to heated forced-air source 40 to receive flow 60 of heated forced air through a forced-air inlet 68 [368] formed in heated forced-air nozzle 12 [312] which is arranged to open into forced-air conduit 11 [311] formed in heated forced-air nozzle 12 [312]. Heated forced-air nozzle 12 [312] includes a first air ring 12R1 [312R1] located in floor-receiving space 28 in spaced-apart relation to male mandrel 20. Heated forced-air nozzle 12 [312] is configured to define a first portion of the forced-air conduit and is formed to include series of circumferentially spaced-apart passageways 12P that are arranged to extend away from mandrel axis 38 along passageway axis 13 to cause a first portion 60A of flow 60 to be communicated from heated forced-air source 40, through forced-air conduit 11 [311], and into the floor-receiving space 28.

Heated forced-air nozzle 12 [312] further includes a ring mount 12A [312A] including a first end 12A1 [312A1] coupled to a central portion 12R1C [312R1C] of first air ring 12R1 [312R1] and a second end 12A2 [312A2] arranged to lie in spaced-apart relation to first air ring 12R1 [312R1] to cause the flow 60 of heated forced air to move around second end 12A2 [312A2] in the forced-air conduit 11.

Heated forced-air nozzle 12 [312] further includes spacer means 12S1, 12S2, 12S3 [312S1, 31252, 31253, 31254, 31255 for locating first air ring 12R1 [312R1] in floor-receiving space 28 between the male mandrel 20 and the second end 12A2 [312A2] of forced-air conduit 11 [311] to cause first portion 60A provided by the first air ring 12R1 [312R1] to transfer heat to a platform-support member 32 [532] included in one of a first insulative container having a first volume and a second insulative container having a relatively greater second volume.

Heated forced-air nozzle 12 [312] further includes spacer means 12S1, 12S2, 12S3 [312S1, 312S2, 312S3, 312S4, 312S5 for locating first air ring 12R1 [312R1] in floor-receiving space 28 between the male mandrel 20 and the second end 12A2 [312A2] of forced-air conduit 11 [311] to cause first portion 60A provided by the first air ring 12R1 [312R1] to transfer heat to a platform-support member 32 [532] included in one of a first insulative container in which the platform-support member has a first axial width W1 and a second insulative container having a relatively greater second axial width W2.

The spacer means includes a first spacer ring 12S1 [312S1] coupled to first air ring 12R1 [312R1]. First spacer ring 12S1 is arranged to extend downwardly away from male mandrel 20 toward second end 12A2 [312A2] of the ring mount 12A. First spacer ring 12S1 has a first thickness 18 when platform-support member 32 is included in the first insulative container. First spacer ring 312S1 has a second thickness 318 when platform-support member 532 is included in the second insulative container. The second thickness 318 is different than the first thickness 18. In one example, the second thickness 318 is less than the first thickness 18.

Heated forced-air nozzle 12 [312] further includes a second air ring 12R2 [312R2] coupled to ring mount 12A [312A] in spaced-apart relation between the first end 12A1 [312A1] and the second end 12A2 [312A2] of ring mount 12A [312A]. Second air ring 12R2 [312R2] is configured to define a second portion of forced-air conduit 11 [311] and formed to include a series of circumferentially spaced-apart passageways 12P that are arranged to extend away from mandrel axis 38 along passageway axis 13 to cause a second portion 60B of flow 60 of heated forced air to be communicated from heated forced-air source 40, through the forced-air conduit 11 [311], and through second air ring 12R2 [312R2].

The spacer means is also for locating second air ring 12R2 [312R2] between first air ring 12R1 [312R1] and second end 12A2 [312A2] of ring mount 12A [312A] to cause second portion 60B of the flow 60 of heated forced air provided by second air ring 12R2 [312R2] to transfer heat to floor-retaining flange 34 when included in the first insulative container and to the platform-support member 532 when included in the second insulative container.

The spacer means includes first spacer ring 12S1 [312S1] and a second spacer ring 12S2 [312S2]. First spacer ring 12S1 [312S1] is arranged to interconnect and extend between first air ring 12R1 [312R1] and second air ring 12R2 [312R2]. Second spacer ring 12S2 [312S2] is coupled to second air ring 12R2 [312R2] and is arranged to extend downwardly away from second air ring 12R2 [312R2] toward the second end 12A2 [312A2] of the ring mount 12A [312A].

Heated forced-air nozzle 12 [312] further includes a third air ring 12R3 [312R3] coupled to ring mount 12A [312A] in spaced-apart relation between second air ring 12R2 [312R2] and second end 12A2 [312A2] of ring mount 12A [312A]. Third air ring 12R [312R3] is configured define a third portion of forced-air conduit 11 [311] and is formed to include a series of circumferentially spaced-apart passageways 12P that are arranged to extend away from mandrel axis 21 along passageway axis 13 to cause a third portion 60A of flow 60 of heated forced air to be communicated from heated forced-air source 40, through forced-air conduit 11 [311], and through third air ring 12R3 [312R3].

The spacer means is also for locating third air ring 12R3 [312R3] between second air ring 1282 [312R2] and second end 12A2 [312A2] of forced-air conduit 11 [311] to cause third portion 60A of flow 60 of heated forced air provided by third air ring 12R3 [312R3] to transfer heat to floor-retaining flange 34 [534] when included in one of the first insulative container and the second insulative container.

The spacer means includes first spacer ring 12S1 [312S1], second spacer ring 12S2 [312S2], and a third spacer ring 312S3. First spacer ring 12S1 [312S1] is coupled to first air ring 12R1 [312R1] and arranged to extend downwardly away from first air ring 12R1 [312R1] toward second air ring 12R2 [312R2]. Second spacer ring 312S2 is coupled to second air ring 312R2 and is arranged to extend downwardly away from second air ring 312R2 toward third air ring 312R3. Third spacer ring 312S3 is coupled to third air ring 312R3 and is arranged to extend downwardly away from third air ring 312R3 toward second end 12A2 [312A2] of ring mount 12A [312A].

In another illustrative example, first spacer ring 12S1 is located between and arranged to extend between first and second air rings 12R1, 12R2. Third air ring 12R3 is coupled to second air ring 12R2 and is arranged to extend between and interconnect second air ring 12R2 and second spacer ring 12S2 as shown in FIGS. 3-8.

Tables 1-11 disclose different arrangements of spacer rings and air rings that may be used with different insulative cups. Variables that may be adjusted include a thickness of each ring, a diameter of each ring, and an acute angle.

TABLE 1
Arrangement of Spacer Rings and Air Rings for Use with a 30 oz.
Insulative Cup

| Ring | Thickness | | Angle of Passageways |
|---|---|---|---|
| Number | (inches) | Ring Diameter | (Degrees) |
| 1 | Base | Small | N/A |
| 2 | 0.023 | Small | N/A |
| 3 | 0.425 | Small | N/A |
| 4 | 0.223 | Small | 15 |
| 5 | 0.110 | Small | N/A |
| 6 | 0.010 | Small | N/A |
| 7 | 0.200 | Small | N/A |
| 8 | 0.024 | Large | N/A |
| 9 | 0.005 | Large | N/A |
| 10 | 0.050 | Large | N/A |
| 11 | 0.250 | Large | 15 |
| 12 | 0.150 | Large | 0 |
| 13 | 0.050 | Large | N/A |
| 14 | Nose | Large | 15 |

TABLE 2
Arrangement of Spacer Rings and Air Rings for Use with a 30 oz.
Insulative Cup

| Ring | Thickness | Ring Diameter | Angle of Passageways |
|---|---|---|---|
| Number | (inches) | (inches) | (Degrees) |
| 1 | 0.525 | 1.580 | N/A |
| 2 | 0.025 | 1.580 | N/A |
| 3 | 0.010 | 1.580 | N/A |
| 4 | 0.050 | 1.580 | N/A |
| 5 | 0.420 | 1.580 | N/A |
| 6 | 0.170 | 1.580 | 15 |
| 7 | 0.050 | 1.580 | N/A |
| 8 | 0.100 | 1.580 | N/A |
| 9 | 0.010 | 1.765 | N/A |
| 10 | 0.100 | 1.765 | N/A |
| 11 | 0.100 | 1.765 | N/A |
| 12 | 0.025 | 1.765 | N/A |
| 13 | 0.200 | 1.765 | 15 |
| 14 | 0.050 | 1.765 | N/A |
| 15 | 0.100 | 1.765 | N/A |
| 16 | 0.200 | 1.765 | 15 |
| 17 | 0.025 | 1.765 | N/A |
| 18 | 0.010 | 1.765 | 15 |

TABLE 3
Arrangement of Spacer Rings and Air Rings for Use with a 30 oz.
Insulative Cup

| Ring | Thickness | Ring Diameter | Angle of Passageways |
|---|---|---|---|
| Number | (inches) | (inches) | (Degrees) |
| 1 | 0.525 | 1.580 | N/A |
| 2 | 0.025 | 1.580 | N/A |
| 3 | 0.010 | 1.580 | N/A |
| 4 | 0.050 | 1.580 | N/A |
| 5 | 0.420 | 1.580 | N/A |
| 6 | 0.170 | 1.580 | 15 |
| 7 | 0.050 | 1.580 | N/A |
| 8 | 0.100 | 1.580 | N/A |
| 9 | 0.010 | 1.765 | N/A |
| 10 | 0.100 | 1.765 | N/A |
| 11 | 0.100 | 1.765 | N/A |
| 12 | 0.025 | 1.765 | N/A |
| 13 | 0.200 | 1.765 | 15 |
| 14 | 0.050 | 1.765 | N/A |
| 15 | 0.100 | 1.765 | N/A |
| 16 | 0.200 | 1.765 | 15 |
| 17 | 0.025 | 1.765 | N/A |
| 18 | 0.010 | 1.765 | 15 |

TABLE 4
Arrangement of Spacer Rings and Air Rings for Use with a 24 oz.
Insulative Cup

| Ring | Thickness | Ring Diameter | Angle of Passageways |
|---|---|---|---|
| Number | (inches) | (inches) | (Degrees) |
| 1 | 0.435 | 1.580 | N/A |
| 2 | 0.100 | 1.580 | N/A |
| 3 | 0.100 | 1.580 | N/A |
| 4 | 0.215 | 1.580 | N/A |
| 5 | 0.150 | 1.580 | 15 |
| 6 | 0.150 | 1.580 | N/A |
| 7 | 0.025 | 1.765 | N/A |
| 8 | 0.180 | 1.765 | 15 |
| 9 | 0.050 | 1.765 | N/A |
| 10 | 0.100 | 1.765 | N/A |
| 11 | 0.050 | 1.765 | N/A |
| 12 | 0.150 | 1.765 | N/A |
| 13 | 0.180 | 1.765 | 15 |
| 14 | 0.100 | 1.765 | N/A |
| 15 | 0.230 | 1.765 | 15 |

TABLE 5
Arrangement of Spacer Rings and Air Rings for Use with a 20 oz.
Insulative Cup

| Ring | Thickness | Ring Diameter | Angle of Passageways |
|---|---|---|---|
| Number | (inches) | (inches) | (Degrees) |
| 1 | 0.525 | 1.580 | N/A |
| 2 | 0.032 | 1.580 | N/A |
| 3 | 0.052 | 1.580 | N/A |
| 4 | 0.100 | 1.580 | N/A |
| 5 | 0.200 | 1.580 | N/A |
| 6 | 0.145 | 1.580 | 15 |
| 7 | 0.026 | 1.580 | N/A |
| 8 | 0.200 | 1.580 | N/A |
| 9 | 0.052 | 1.580 | N/A |
| 10 | 0.100 | 1.580 | N/A |
| 11 | 0.071 | 1.580 | N/A |
| 12 | 0.170 | 1.765 | 15 |
| 13 | 0.057 | 1.765 | N/A |
| 14 | 0.170 | 1.765 | 15 |
| 15 | 0.011 | 1.765 | N/A |
| 16 | 0.062 | 1.765 | N/A |
| 17 | 0.222 | 1.765 | 15 |

TABLE 6
Arrangement of Spacer Rings and Air Rings for Use with a 20 oz.
Insulative Cup

| Ring | Thickness | Ring Diameter | Angle of Passageways |
|---|---|---|---|
| Number | (inches) | (inches) | (Degrees) |
| 1 | 0.025 | Small | N/A |
| 2 | 0.050 | Small | N/A |
| 3 | 0.200 | Small | N/A |
| 4 | 0.145 | Small | N/A |
| 5 | 0.100 | Small | 15 |
| 6 | >.200 | Small | N/A |
| 7 | 0.170 | Large | N/A |
| 8 | 0.050 | Large | 15 |
| 9 | 0.200 | Large | N/A |
| 10 | 0.170 | Large | N/A |
| 11 | 0.010 | Large | 15 |
| 12 | 0.100 | Large | N/A |
| 13 | nose | Large | N/A |
| 14 | 0.025 | Large | N/A |

TABLE 7
Arrangement of Spacer Rings and Air Rings for Use with a 16 oz.
Insulative Cup

| Ring | Thickness | Ring Diameter | Angle of Passageways |
|---|---|---|---|
| Number | (inches) | (inches) | (Degrees) |
| 1 | 0.640 | 1.580 | N/A |
| 2 | 0.020 | 1.580 | N/A |
| 3 | 0.050 | 1.580 | N/A |
| 4 | 0.100 | 1.580 | N/A |
| 5 | 0.210 | 1.580 | 75 |
| 6 | 0.150 | 1.580 | N/A |
| 7 | 0.235 | 1.580 | 75 |
| 8 | 0.010 | 1.580 | N/A |
| 9 | 0.200 | 1.765 | N/A |
| 10 | 0.235 | 1.765 | 75 |
| 11 | 0.025 | 1.765 | N/A |
| 12 | 0.050 | 1.765 | N/A |
| 13 | 0.300 | 1.765 | 75 |

TABLE 8
Arrangement of Spacer Rings and Air Rings for Use with a 16 oz.
Insulative Cup

| Ring | Thickness | | Angle of Passageways |
|---|---|---|---|
| Number | (inches) | Ring Diameter | (Degrees) |
| 1 | base | Small | N/A |
| 2 | 0.150 | Small | N/A |
| 3 | 0.050 | Small | N/A |
| 4 | 0.100 | Small | 15 |
| 5 | 0.010 | Small | N/A |
| 6 | 0.025 | Small | N/A |
| 7 | 0.190 | Small | 15 |
| 8 | 0.215 | Small | N/A |
| 9 | 0.190 | Large | N/A |
| 10 | 0.030 | Large | N/A |
| 11 | 0.150 | Large | N/A |
| 12 | 0.190 | Large | N/A |
| 13 | 0.100 | Large | N/A |
| 14 | nose | Large | N/A |

TABLE 9
Arrangement of Spacer Rings and Air Rings for Use with a 16 oz.
Insulative Cup

| Ring | Thickness | Angle of Passageways |
|---|---|---|
| Number | (inches) | (Degrees) |
| 1 | 0.525 | N/A |
| 2 | 0.010 | N/A |
| 3 | 0.010 | N/A |
| 4 | 0.010 | 15 |
| 5 | 0.005 | N/A |
| 6 | 0.215 | N/A |
| 7 | 0.050 | 15 |
| 8 | 0.005 | N/A |
| 9 | 0.005 | N/A |
| 10 | 0.005 | N/A |
| 11 | 0.025 | N/A |
| 12 | 0.193 | N/A |
| 13 | 0.005 | N/A |
| 14 | 0.050 | N/A |
| 15 | 0.050 | N/A |
| 16 | 0.050 | N/A |
| 17 | 0.025 | N/A |
| 18 | 0.025 | N/A |
| 19 | 0.025 | N/A |
| 20 | 0.195 | 15 |
| 21 | 0.005 | N/A |
| 22 | 0.005 | N/A |
| 23 | 0.005 | N/A |
| 24 | 0.010 | N/A |
| 25 | 0.010 | N/A |
| 26 | 0.025 | N/A |
| 27 | 0.100 | N/A |
| 28 | 0.010 | N/A |
| 29 | 0.010 | N/A |
| 30 | 0.192 | 15 |
| 31 | 0.100 | N/A |
| 32 | 0.255 | 15 |

TABLE 10
Arrangement of Spacer Rings and Air Rings for Use with a 12 oz.
Insulative Cup

| Ring | Thickness | | Angle of Passageways |
|---|---|---|---|
| Number | (inches) | Ring Diameter | (Degrees) |
| 1 | base | Small | N/A |
| 2 | 0.150 | Small | N/A |
| 3 | 0.025 | Small | N/A |
| 4 | 0.010 | Small | N/A |
| 5 | 0.100 | Small | N/A |
| 6 | 0.100 | Small | N/A |
| 7 | 0.150 | Small | N/A |
| 8 | 0.050 | Small | N/A |
| 9 | 0.005 | Small | N/A |
| 10 | 0.025 | Small | N/A |
| 11 | 0.100 | Small | N/A |
| 12 | 0.190 | Small | 15 |
| 13 | 0.010 | Small | N/A |
| 14 | 0.005 | Small | N/A |
| 15 | 0.005 | Large | N/A |
| 16 | 0.010 | Large | N/A |
| 17 | 0.005 | Large | N/A |
| 18 | 0.01 | Large | N/A |
| 19 | 0.005 | Large | N/A |
| 20 | 0.005 | Large | N/A |
| 21 | 0.150 | Large | N/A |
| 22 | 0.190 | Large | 15 |
| 23 | 0.190 | Large | 15 |
| 24 | nose | Large | N/A |

TABLE 11
Arrangement of Spacer Rings and Air Rings for Use with a 12 oz.
Insulative Cup

| Ring | Thickness | | Angle of Passageways |
|---|---|---|---|
| Number | (inches) | Ring Diameter | (Degrees) |
| 1 | base | Small | N/A |
| 2 | 0.024 | Small | N/A |
| 3 | 0.200 | Small | N/A |
| 4 | 0.200 | Small | N/A |
| 5 | 0.160 | Small | 15 |
| 6 | 0.200 | Small | N/A |
| 7 | 0.180 | Large | 15 |
| 8 | 0.010 | Large | N/A |
| 9 | 0.050 | Large | N/A |
| 10 | 0.200 | Large | N/A |
| 11 | 0.180 | Large | 15 |
| 12 | 0.025 | Large | N/A |
| 13 | 0.100 | Large | N/A |
| 14 | Nose | Large | N/A |

1. A container-forming machine comprising
a mandrel arranged to extend along a mandrel axis and formed to include a floor-receiving aperture arranged to open into a floor-receiving space formed in the mandrel and
a heated forced-air nozzle adapted to be coupled to a heated forced-air source configured to provide a flow of heated forced air to a forced-air inlet formed in the heated forced-air nozzle which is arranged to open into a forced-air conduit formed in the heated forced-air nozzle, the heated forced-air nozzle including
a first air ring located in the floor-receiving space in spaced-apart relation to the mandrel, configured to define a first portion of the forced-air conduit, and formed to include a series of circumferentially spaced apart passageways that are arranged to extend away from the axis along a passageway axis to cause a first portion of the flow of heated forced air to be communicated from the heated forced-air source, through the forced-air conduit, and into the floor-receiving space,
a ring mount including a first end coupled to a central portion of the first air ring and a second end arranged to lie in spaced-apart relation to the first air ring to cause the flow of heated forced air to move around the second end in the forced-air conduit, and
spacer means for locating the first air ring in the floor-receiving space between the mandrel and the second end of the ring mount to cause the first portion of the flow of heated forced air provided by the first air ring to transfer heat to a platform-support member included in one of a first insulative container in which the platform-support member has a first axial width and a second insulative container having a relatively greater second axial width.

2. The container-forming machine of claim 1, wherein the spacer means includes a first spacer ring coupled to the first air ring and arranged to extend downwardly away from the mandrel toward the second end of the ring mount.

3. The container-forming machine of claim 2, wherein first spacer ring has a first thickness when the platform-support member is included in the first insulative container.

4. The container-forming machine of claim 3, wherein the first spacer ring has a second thickness when the platform-support member is included in the second insulative container and the second thickness is different than the first thickness.

5. The container-forming machine of claim 4, wherein the second thickness is less than the first thickness.

6. The container-forming machine of claim 1, wherein each spaced-apart passageway included in the series of circumferentially spaced-apart passageways is configured to provide means for directing a first stream of heated forced air included in the first portion of the flow of heated forced air to be directed into the platform-support member and a second stream of heated forced air included in the first portion to be directed away from the mandrel, out of the floor-receiving space, toward the second end of the ring mount so that damage done to the floor-retaining flange as a result of burning is minimized.

7. The container-forming machine of claim 6, wherein the passageway axis intersects the mandrel axis at an acute angle.

8. The container-forming machine of claim 7, wherein the acute angle is in a range of up to about 45 degrees to about 90 degrees.

9. The container-forming machine of claim 8, wherein the acute angle is in a range of up to about 60 degrees to about 90 degrees.

10. The container-forming machine of claim 9, wherein the acute angle is in a range of up to about 70 degrees to about 85 degrees.

11. The container-forming machine of claim 10, wherein the acute angle is in a range of up to about 70 degrees to about 80 degrees.

12. The container-forming machine of claim 11, wherein the acute angle is about 75 degrees.

13. The container-forming machine of claim 12, wherein the spacer means includes a first spacer ring coupled to the first air ring and arranged to extend downwardly away from the mandrel toward the second end of the ring mount.

14. The container-forming machine of claim 1, wherein the heated forced-air nozzle further includes a second air ring coupled to the ring mount in spaced-apart relation the first air ring between the first end and the second ends of the ring mount, configured to define a second portion of the forced-air conduit, and formed to include a series of circumferentially spaced apart passageways that are arranged to extend away from the mandrel axis along a passageway axis to cause a second portion of the flow of heated forced air to be communicated from the heated forced-air source, through the forced-air conduit, and through the second air ring.

15. The container-forming machine of claim 14, wherein the spacer means is also for locating the second air ring between the first air ring and the second end of the ring mount to cause the second portion of the flow of heated forced air provided by the second air ring to transfer heat to a floor-retaining flange when included in the first insulative container and to the platform-support member when the platform-support member is in included in the second insulative container.

16. The container-forming machine of claim 15, wherein the spacer means includes a first spacer ring coupled to the first air ring and arranged to extend downwardly away from the first air ring toward the second air ring and a second spacer ring coupled to the second air ring and arranged to extend downwardly away from the second air ring toward the second end of the ring mount.

17. The container-forming machine of claim 14, wherein the heated forced-air nozzle further includes a third air ring coupled to the ring mount in spaced-apart relation between the second air ring and the second end of the ring mount, configured define a third portion of the forced-air conduit, and formed to include a series of circumferentially spaced apart passageways that are arranged to extend away from the mandrel axis along a passageway axis to cause a third portion of the flow of heated forced air to be communicated from the heated forced-air source, through the forced-air conduit, and through the third air ring.

18. The container-forming machine of claim 17, wherein the spacer means is also for locating the third air ring between the second air ring and the second end of the ring mount to cause the third portion of the flow of heated forced air provided by the third air ring to transfer heat to the floor-retaining flange when included in one of the first insulative container and the second insulative container.

19. The container-forming machine of claim 18, wherein the spacer means includes a first spacer ring coupled to the first air ring and arranged to extend downwardly away from the first air ring toward the second air ring, a second spacer ring coupled to the second air ring and arranged to extend downwardly away from the second air ring toward the third air ring, and a third spacer ring coupled to the third air ring and arranged to extend downwardly away from the third air ring toward the second end of the ring mount.

20. The container-forming machine of claim 17, wherein the heated forced-air nozzle further includes a fourth air ring coupled to the ring mount in spaced-apart relation between the third air ring and the second end of the ring mount, configured define a fourth portion of the forced-air conduit, and formed to include a series of circumferentially spaced apart passageways that are arranged to extend away from the axis along a passageway axis to cause a fourth portion of the flow of heated forced air to be communicated from the heated forced-air source, through the forced-air conduit, and through the fourth air ring.

21. The container-forming machine of claim 20, wherein the spacer means is also for locating the fourth air ring between the third air ring and the second end of the ring mount to cause the third portion of the flow of heated forced air provided by the forth air ring to transfer heat to the floor-retaining flange when included in one of the first insulative container and the second insulative container.

22. The container-forming machine of claim 21, wherein the spacer means includes a first spacer ring coupled to the first air ring and arranged to extend downwardly away from the first air ring toward the second air ring, a second spacer ring coupled to the second air ring and arranged to extend downwardly away from the second air ring toward the third air ring, a third spacer ring coupled to the third air ring and arranged to extend downwardly away from the third air ring toward the fourth air ring, and a fourth spacer ring coupled to the fourth air ring and arranged to extend downwardly away from the fourth air ring toward the second end of the ring mount.

23. The container-forming machine of claim 22, wherein the first spacer ring includes a first sub-ring layer coupled to the first air ring and a second sub-ring layer coupled to the first sub-ring layer to locate the first sub-ring layer between the first air ring and the second sub-ring layer.

24. A heated forced-air nozzle for a cup-forming machine, the heated forced-air nozzle comprising
a ring mount adapted to couple to a source of heated forced air,
a first air ring coupled to the nozzle mount and formed to include a first portion of a forced-air conduit therein and a series of circumferentially spaced-apart passageways formed therein, the first portion of the heated-air passageway being in fluid communication with the source of heated forced air, and the series of circumferentially spaced-apart passageways being in fluid communication with the first portion of the forced-air conduit, and
spacer means for locating the first ring to cause heated force air to be directed onto a floor-retaining flange included in a side wall during formation of an insulated container.

25. The heated forced-air nozzle of claim 24, wherein each spaced-apart passageway included in the series of circumferentially spaced-apart passageways is arranged to extend radially outward along a passageway axis away from a reference plane toward the nozzle mount and the axis extends through the reference plane so as to define an angle between the reference plane and the axis to cause a portion of the heated forced air to move away from the reference plane toward the nozzle mount so that damage done to the floor-retaining flange as a result of burning is minimized.

26. The heated forced-air nozzle of claim 25, wherein the angle is in a range of about 10 degrees to about 20 degrees.

27. The heated forced-air nozzle of claim 26, wherein the angle is about 15 degrees.
